(19) United States
(12) Patent Application Publication
(10) Pub. No.: US 2014/0043683 A1
(43) Pub. Date: Feb. 13, 2014

(54) OPTICAL SHEET ASSEMBLY AND DISPLAY APPARATUS HAVING THE SAME

(71) Applicants: Jong-Kap JO, Yongin-City (KR); Chung-Soo HA, Yongin-City (KR)

(72) Inventors: Jong-Kap JO, Yongin-City (KR); Chung-Soo HA, Yongin-City (KR)

(21) Appl. No.: 13/921,309

(22) Filed: Jun. 19, 2013

(30) Foreign Application Priority Data
Aug. 8, 2012 (KR) 10-2012-0086621

(51) Int. Cl. G02B 5/30

(52) U.S. Cl. CPC G02B 5/3033
USPC 359/483.01

(57) ABSTRACT

An optical sheet assembly disposed on a display panel including a pixel area displaying an image and a peripheral area surrounding the pixel area, the optical sheet assembly includes a polarizing plate on the display panel, a light blocking pattern on the polarizing plate, a portion of the polarizing plate in the pixel area being exposed through openings in the light blocking pattern, and a hard coating layer on the polarizing plate, the hard coating layer covering an upper surface of the light blocking pattern and the exposed portion of the polarizing plate in the pixel area.

### CROSS REFERENCE TO RELATED APPLICATION

This application claims priority under 35 U.S.C. §119 to Korean patent Application No. 2012-0086621, filed on Aug. 8, 2012, the disclosure of which is hereby incorporated by reference herein in its entirety.

### BACKGROUND

1. Technical Field

Example embodiments of the inventive concept relate to an optical sheet assembly and a display apparatus having the optical sheet assembly. More particularly, example embodiments of the inventive concept relate to an optical sheet assembly having reduced number of elements and a display apparatus having the optical sheet assembly ensuring improved assemblage efficiency.

2. Description of the Related Art

A thin film display device is advantageous due to its light weight, small thickness, low power consumption, etc. Examples of a thin film display device may include an organic light emitting diode (OLED) display device, a liquid crystal display device, an electrophoretic display (EPD) device, etc.

An OLED display device may display desired information, e.g., images, letters and/or characters, using light generated by combining holes provided from an anode with electrons provided from a cathode in an organic layer thereof. The OLED display device has various characteristics, e.g., relatively large view angle, rapid response speed, small thickness, low power consumption, etc. Accordingly, the OLED display device is one of the next-generation display devices.

### SUMMARY

Example embodiments provide an integrally formed optical sheet assembly having a reduced number of parts.

Example embodiments provide a display device including an integrally formed optical sheet assembly having a reduced number of input pins and a small size.

According to one aspect of example embodiments, an optical sheet assembly disposed on a display panel including a pixel area displaying an image and a peripheral area surrounding the pixel area, the optical sheet assembly includes a polarizing plate on the display panel, a light blocking pattern on the polarizing plate, a portion of the polarizing plate in the pixel area being exposed through openings in the light blocking pattern, and a hard coating layer on the polarizing plate, the hard coating layer covering an upper surface of the light blocking pattern and the exposed portion of the polarizing plate in the pixel area.

In example embodiments, the optical sheet assembly may further include an information pattern directly printed on the polarizing plate. The information pattern may display at least one selected from the group consisting of a company logo, a proprietary name and an identification number.

In example embodiments, the polarizing plate may include a first polarizing plate and a second polarizing plate. The light blocking pattern may be interposed between the first and the second polarizing plates.

In example embodiments, an opening may be defined by the opening part of the light blocking pattern, the upper surface of the first polarizing plate and the lower surface of the second polarizing plate

In example embodiments, the opening may be vacuum or may be filled with at least one selected from the group consisting of air, nitrogen, and argon gas.

In example embodiments, the optical sheet assembly may further include an overcoating layer. The overcoating layer may be disposed in the opening to cover a side surface of the light blocking pattern.

In example embodiments, the optical sheet assembly further may include an overcoating layer. The overcoating layer may be disposed between the hard coating layer and the light blocking pattern to cover the light blocking pattern.

According to example embodiments, there is provided an optical sheet assembly. The optical sheet assembly is disposed on a display panel. The display panel includes a pixel area displaying an image and a peripheral area surrounding the pixel area. The optical sheet assembly includes a polarizing plate, a light blocking pattern and a hard coating layer. The polarizing plate is disposed on the display panel. The light blocking pattern is directly printed on the polarizing plate. The light blocking pattern is disposed between the display panel and the polarizing plate. The portion of the light blocking pattern corresponding to the pixel area is opened. The hard coating layer is formed on the polarizing plate.

According to example embodiments, there is provided an optical sheet assembly. The optical sheet assembly is disposed on a display panel. The display panel includes a pixel area displaying an image and a peripheral area surrounding the pixel area. The optical sheet assembly includes a base substrate, a blocking light pattern, a polarizing pattern and a hard coating layer. The base substrate is disposed on the display panel. The blocking light pattern is disposed on the base panel and the pixel area. The polarizing pattern disposed on the base substrate in the pixel area. The hard coating layer is formed on the base substrate.

In example embodiments, the hard coating layer may be disposed on the base substrate, on which the light blocking pattern and the polarizing pattern are formed, to cover an upper surface of the light blocking pattern and the polarizing pattern.

In example embodiments, the polarizing pattern may include a grid pattern.

According to example embodiments, there is also provided a display device including a pixel area displaying an image and a peripheral area surrounding the pixel area, and an optical sheet assembly on the display panel, the optical sheet assembly including a polarizing plate, a light blocking pattern and a hard coating layer. The polarizing plate is disposed on the display panel. The light blocking pattern is directly printed on the polarizing plate, a portion of the light blocking pattern corresponding to the pixel area being opened. The hard coating layer is disposed on the polarizing plate, on which the light blocking pattern is formed, to cover an upper surface of the light blocking pattern and the portion of the polarizing plate exposed through the pixel area.

In example embodiments, the display device may further include an information pattern directly printed on the polarizing plate. The information pattern may display at least one selected from the group consisting of a company logo, a proprietary name and an identification number.

In example embodiments, the polarizing plate may include a first polarizing plate and a second polarizing plate. The light blocking pattern may be interposed between the first polarizing plate and the second polarizing plate.

In example embodiments, an opening may be defined by the opened portion of the light blocking pattern, an upper surface of the first polarizing plate and a lower surface of the second polarizing plate.

In example embodiments, the display device may further include an overcoating layer. The overcoating layer may be disposed between the hard coating layer and the light block pattern to cover the light blocking pattern.

In example embodiments, the display panel may include organic electro-luminescent display panel, liquid crystal display panel or electrophoresis display panel.

In example embodiments, the display panel may further include a first substrate, a switching device and a display element. The switching device may be disposed on the first substrate. The display element may be electrically connected to the switching element.

In example embodiments, the electrode of the display element may be covered by the optical sheet assembly.

In example embodiments, the display panel may further include a second substrate and the optical sheet assembly. The second substrate may cover the display element. The optical sheet assembly may be disposed on the second substrate.

### BRIEF DESCRIPTION OF THE DRAWINGS

Example embodiments can be understood in more detail from the following description taken in conjunction with the accompanying drawings, in which:

FIG. 1 is an exploded perspective view of a display device in accordance with example embodiments;

FIG. 2 is a cross-sectional view illustrating the display device of FIG. 1;

FIG. 3 is an enlarged cross-sectional view along line I-I′ of FIG. 1;

FIG. 4 is a cross-sectional view illustrating a display device in accordance with another example embodiment;

FIG. 5 is a cross-sectional view illustrating a display device in accordance with another example embodiment;

FIG. 6 is a cross-sectional view illustrating a display device in accordance with another example embodiment;

FIG. 7 is a cross-sectional view illustrating a display device in accordance with another example embodiment;

FIG. 8 is a cross-sectional view illustrating a display device in accordance with another example embodiment;

FIG. 9 is a cross-sectional view illustrating a display device in accordance with another example embodiment;

FIG. 10 is a cross-sectional view illustrating a display device in accordance with another example embodiment;

FIG. 11 is a cross-sectional view illustrating a display device in accordance with another example embodiment;

FIG. 12 is a cross-sectional view illustrating a display device including a level shifting device in accordance with example embodiments;

FIG. 13 is a cross-sectional view illustrating a display device including a level shifting device in accordance with another example embodiment;

FIG. 14A is a cross-sectional view illustrating an optical film according to an exemplary embodiment of the present invention;

FIG. 14B is an image illustrating a surface of the optical film of FIG. 14A;

FIG. 15A is a cross-sectional view illustrating an optical film according to an exemplary embodiment;

FIG. 15B is an image illustrating a surface of the optical film described with reference to FIG. 15A;

FIG. 16A is a cross-sectional view illustrating an optical film according to an exemplary embodiment;

FIG. 16B is an image illustrating a surface of the optical film described with reference to FIG. 16A;

FIG. 17A is a cross-sectional view illustrating an optical film according to an exemplary embodiment;

FIG. 17B is an image illustrating a surface of the optical film described with reference to FIG. 17A;

FIG. 18A is a cross-sectional view illustrating an optical film according to an exemplary embodiment; and

FIG. 18B is an image illustrating a surface of the optical film described with reference to FIG. 18A.

### DESCRIPTION OF EMBODIMENTS

The example embodiments are described more fully hereinafter with reference to the accompanying drawings. The inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross sectional illustrations that are schematic illustrations of illustratively idealized example embodiments (and intermediate structures) of the inventive concept. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

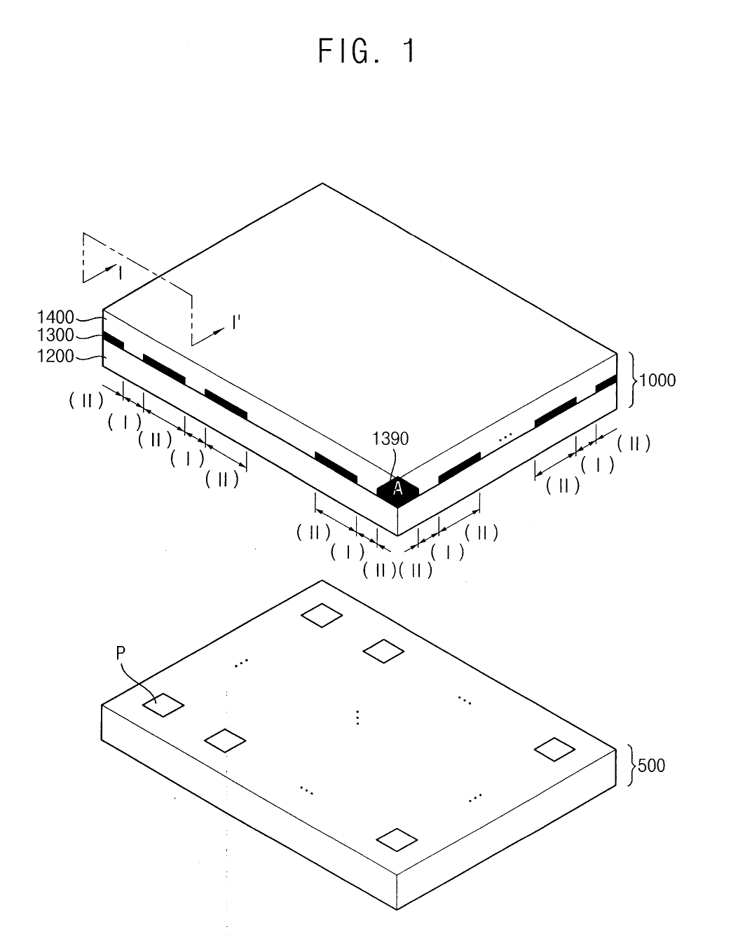

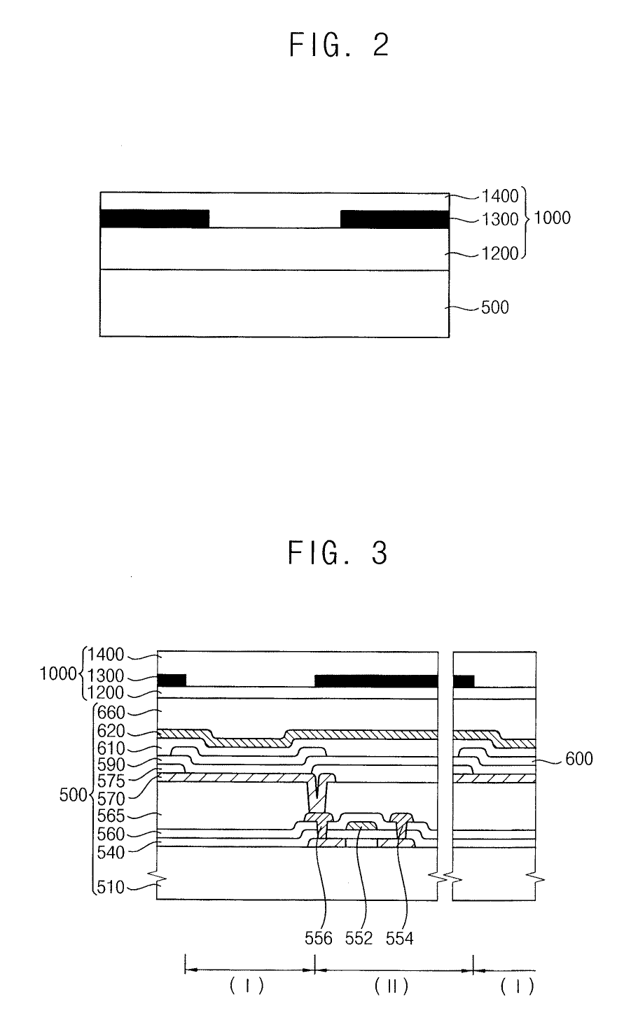

FIG. 1 is a perspective view schematically illustrating a display device in accordance with example embodiment. FIG. 2 is a cross-sectional of the display device in FIG. 1, and FIG. 3 is a detailed cross-sectional view along line I-I′ of FIG. 1.

Referring to FIGS. 1 to 3, a display device includes an optical sheet assembly 1000 and a display panel 500.

The optical sheet assembly 1000 includes a polarizing plate 1200, a light blocking pattern 1300, and a hard coating layer 1400. The polarizing plate 1200, the light blocking pattern 1300, and the hard coating layer 1400 are integrally formed with the optical sheet assembly 1000. In this exemplary embodiment, the optical sheet assembly 1000 is disposed on the display panel 500. The optical sheet assembly 1000 is integrally attached to the display panel 500 to form a display device.

The polarizing plate 1200 polarizes light exiting from the display panel 500 to display an image on the display device. For example, the polarizing plate 1200 includes triacetate cellulose (TAC) film, polycarbonate (PC) film, polyvinyl acetate (PVA) film, grid polarizing plate, an anisotropic mineral substrate such as calcite, etc. The polarizing plate 1200 is disposed on the display panel 500 to make contact with an upper surface of the display panel 500. In this exemplary embodiment, an entire surface of the polarizing plate 1200 is integrally combined with the entire upper surface of the display panel 500 to form the display device. A transparent film (not shown) such as a retardation film (not shown), a TAC film, a PC film, a PVA film, etc. may be interposed between the polarizing plate 1200 and the display panel 500.

The light blocking pattern 1300 blocks a portion of light having passed through the polarizing plate 1200 to improve a ratio of an image. The light blocking pattern 1300 may be formed on, e.g., directly on, the polarizing plate 1200 by printing, a photo process, a photo resist process, etc. For example, the light blocking pattern 1300 is formed by printing an opaque material, e.g., ink, dye, ink, metal, etc., on the polarizing plate 1200, or is formed by depositing a metal film on the polarizing plate 1200 and partially etching the deposited metal film by a photo resist process. The light blocking 1300 may have various colors, e.g., black, white, silver, etc. The light blocking pattern 1300 may correspond to the pixel area I and block a peripheral area II. In other words, the patterns of the light blocking pattern 1300 may block light in the peripheral area II and may define overlapping the pixel areas I, e.g., so light from the polarizing plate 1200 may pass only through the openings of the light blocking pattern 1300. An information pattern 1390 displaying, e.g., a company logo, a proprietary name, an identification number, etc., may be formed in the same layer as the light blocking pattern 1300. A transparent film (not shown) such as a TAC film, a PC film, a PVA film, etc. may be disposed on the light blocking pattern 1300.

The hard coating layer 1400 disposed on the polarizing plate 1200, on which the light blocking pattern 1300 is formed, covers the light blocking pattern 1300 and the polarizing plate 1200. In this exemplary embodiment, the hard coating layer 1400 directly contacts an upper surface of the light blocking pattern 1300 and the polarizing plate 1200, e.g., the hard coating layer 1400 is in the openings of the light blocking pattern 1300 to directly contact the polarizing plate 1200 through the openings in the light blocking pattern 1300. For example, the hard coating layer 1400 may be an outermost layer of the optical sheet assembly 1000, and may improve a surface hardness of the optical sheet assembly 1000 to protect the optical sheet assembly 1000 from external impact, e.g., shock, scratch, etc.

The hard coating layer 1400 includes an inorganic material, e.g., SiOx, SiNx, and/or chrome, etc., or includes a highly polymerized compound, e.g., acryl, acrylate, and/or polycarbonate. When the hard coating layer 1400 includes the inorganic material, the hard coating layer 1400 may be formed by an evaporating process. When the hard coating layer 1400 includes the organic material, the hard coating layer 1400 may be formed by coating the organic material on the polarizing plate 1200 and the light blocking pattern 1300, followed by applying a heat-treatment process to the coated organic material to form the hard coating layer 1400.

The hard coating layer 1400 may include a low-reflection coating, e.g., the hard coating layer 1400 may be a low-reflection layer. The low-reflection coating may include, e.g., chrome, silica particles, etc. For example, the hard coating layer 1400 having the low-reflection coating may be formed by depositing chrome on the polarizing plate 1200, on which the light blocking pattern 1300 is formed.

The display panel 500 may include a pixel area I and a peripheral area II surrounding the pixel area I. In an exemplary embodiment, the pixel area I may have substantially the same area and shape, respectively.

The display panel 500 may include a first substrate 510, switching structures, a first electrode 570, display devices, a second electrode 620, etc. In this exemplary embodiment, the display device includes a light emitting structure. For example, the organic luminescent display device described with reference to FIG. 1 or 3 may have a bottom illumination structure. In this exemplary embodiment, the light emitting structure includes an organic electroluminescence element. In another exemplary embodiment, the display device may include a crystal control device controlling a light transmittance thereof, a light-shutter device, an electrophoresis device, etc.

The switching structures may be disposed on a first substrate 510. The first electrode 570 may be situated on the switching structures and may be electrically connected to the switching structures. The light emitting structures may be disposed between the first electrode 570 and the second electrode 620.

The first substrate 510 may include a transparent insulation substrate. In this exemplary embodiment, the first substrate 510 may include, e.g., a glass substrate, a quartz substrate, a transparent plastic substrate, etc. For example, the first substrate 510 may include a transparent resin, e.g., a polyethylene terephthalate resin, a polyester resin, a polyacryl resin, a polyepoxy resin, a polyethylene resin, a polystyrene resin, a polyethylene naphthalate resin, a polycarbonate resin, a polyvinylchloride resin, a polypropylene resin, a cyclo-olefin copolymer, a triacetyl cellulose, a mixture thereof, etc. In other exemplary embodiments, the first substrate 510 may include a flexible substrate.

When the organic light emitting display device is an active matrix type, the switching structure may be interposed between the first substrate 510 and the first electrode 570. In exemplary embodiments, the switching structures may respectively include switching devices, e.g., a thin film transistor (TFT) and multiple insulation layers. When the switching device in the switching structure includes a TFT, the switching device may include a gate electrode 552, a source electrode 554, a drain electrode 556, a semiconductor layer 530, etc.

A gate signal may be applied to the gate electrode 552 while a data signal may be applied to the source electrode 554. The drain electrode 556 may be electrically connected to the first electrode 570. The semiconductor layer 530 may make electrical contact with the source electrode 554 and the drain electrode 556. The semiconductor layer 530 may include a source region 534 contacting the source electrode 554, a drain region 536 contacting the drain electrode 556 and a channel region 532 between the source region 534 and the drain region 536.

A gate insulation layer 540 electrically insulating the gate electrode 552 from the semiconductor layer 530 may be disposed on the semiconductor layer 530. A first insulation layer 560 may be disposed on the gate insulation layer 540 to cover the gate electrode 552.

In the switching device illustrated in FIG. 3, the TFT may have a top gate structure. In the top gate structure, the gate electrode 552 is disposed over the semiconductor layer 530. However, the switching device may have various structures. For example, the TFT may have a bottom gate structure. In the bottom gate structure, a gate electrode may be disposed under the semiconductor layer.

A second insulation layer 565 may be disposed on the first insulation layer 560 to cover the source electrode 554 and the drain electrode 556. In example embodiments, the second insulation layer 565 may have a substantially flat surface obtained by a planarization process

Each of the light emitting structures may include a hole transfer layer (HIL) 590, an organic light emitting layer (EL) 600, an electron transfer layer (ETL) 610, etc. In exemplary embodiments, the organic light emitting layer 600 may include an organic material or a mixture of organic materials and inorganic materials for generating a red color of light, a green color of light, and/or a blue color of light. In some example embodiments, the organic light emitting layer 600 may have a stacked structure that includes a plurality of light emitting films for generating light having the different wavelengths.

The first electrode 570 may be disposed between the switching structure and the light emitting structure. A second electrode 620 may be disposed between the light emitting structure and a second substrate 660. A pixel defining layer 575 may be disposed in a region between the switching structure and the light emitting structure where the first electrode 570 is not positioned.

In example embodiments, the first electrode 570 may be an anode for providing holes into the hole transfer layer 590 of the light emitting structure. The second electrode 620 may be a cathode for supplying electrons into the electron transfer layer 610. Depending on an emission type of the OLED display device, the first electrode 570 may be a transparent electrode or a semi-transparent electrode, and the second electrode 620 may be a reflective electrode. For example, the first electrode 570 may include a transparent conductive material, e.g., indium tin oxide (ITO), zinc tin oxide (ZTO), indium zinc oxide (IZO), zinc oxide (ZnOx), tin oxide (SnOx), gallium oxide (GaOx), etc. The second electrode 620 may include a reflective material, e.g., aluminum (Al), tungsten (W), copper (Cu), nickel (Ni), chromium (Cr), molybdenum (Mo), titanium (Ti), platinum (Pt), silver (Ag), tantalum (Ta), ruthenium (Ru), alloys thereof, nitrides thereof, etc. These may be used alone or in a combination thereof.

The second substrate 660 may be disposed on the second electrode 620. The second substrate 660 may include a transparent substrate. In this exemplary embodiment, the second 660 substrate may include, e.g., a glass substrate, a transparent plastic substrate, etc. For example, the second substrate 660 may include a transparent resin, e.g., a polyethylene terephthalate resin, a polyester resin, a polyacryl resin, a polyepoxy resin, a polyethylene resin, a polystyrene resin, a polyethylene naphthalate resin, a polycarbonate resin, a polyvinylchloride, a polypropylene resin, a cyclo olefin copolymer, triacetyl cellulose, a mixture of thereof, etc. Meanwhile, the second substrate 660 may include a flexible substrate. In this exemplary embodiment, the second substrate 660 may include substantially the same material as the first substrate 510, or the first substrate 510 and the second substrate 660 may include different materials.

In this exemplary embodiment, the hard coating layer 1400 is directly formed on the polarizing plate 1200 and on light blocking pattern 1300. Thus, extra glass substrate and synthetic resin will be omitted.

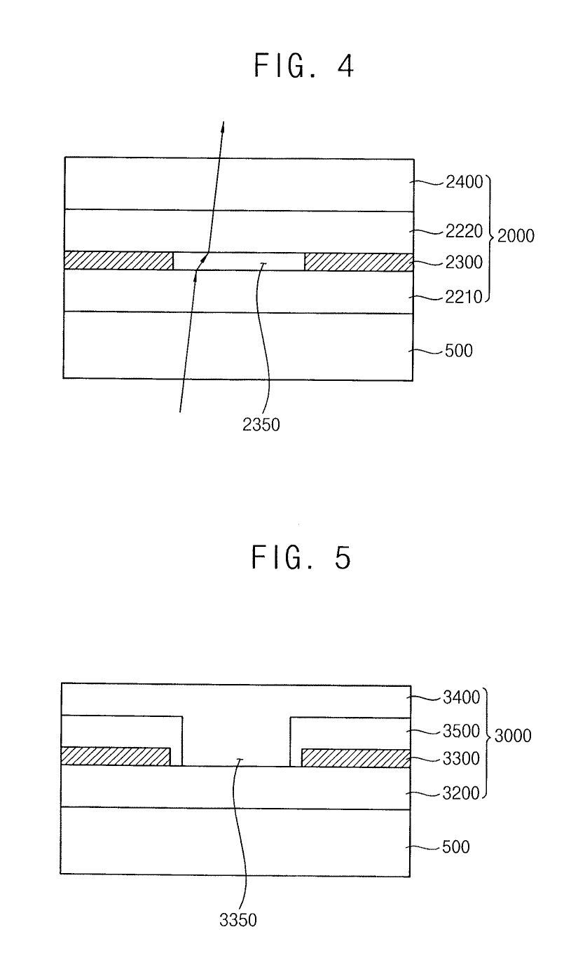

FIG. 4 is a cross-sectional view illustrating a display device in accordance with another example embodiment. In this exemplary embodiment, parts except a light blocking pattern 2300, a first polarizing plate 2210, and a second polarizing plate 2220 are substantially the same as in the exemplary embodiment described with reference to FIGS. 1 to 3. Thus, detailed descriptions thereof will be omitted.

Referring to FIG. 4, an optical assembly 2000 includes the first polarizing plate 2210, the light blocking pattern 2300, the second polarizing plate 2220, and a hard coating layer 2400. The polarizing plate 2210, the light blocking pattern 2300, the second polarizing plate 2220, and the hard coating layer 2400 are integrally formed within the optical sheet assembly 2000. The optical sheet assembly 2000 is disposed on the display panel 500. In this exemplary embodiment, the optical sheet assembly 2000 is integrally attached to the display panel 500 to form the display device.

The first firstly polarizing plate 2210 polarizes light exiting from the display panel 500. The first polarizing plate 2210 is disposed on the display panel 500 to contact the upper surface of the display panel 500. In this exemplary embodiment, an entire surface of the first polarizing plate 2210 is combined with an entire surface of the display panel 500.

The light blocking pattern 2300 blocks a portion of the light having passed through the polarizing plate 2210 to improve a contrast ratio of an image. The light blocking pattern 2300 may be formed by printing, a photo process, a photo resist process, etc.

The second polarizing plate 2220 polarizes polarized light that passes through an opening 2350 of the light blocking pattern 2300. In this exemplary embodiment, a degree of the polarized light by the first and the second polarizing is the same as the degree described with reference to FIGS. 1 to 3.

The second polarizing plate 2220 is disposed on the light blocking pattern 2300 to form a space for the opening 2350. That is, the light blocking pattern 2300 is between the first and second polarizing plates 2210 and 2220, so the opening in the light blocking pattern 2300 define empty spaces between the first and second polarizing plates 2210 and 2220. For example, a space in the opening 2350 includes vacuum or is filled with at least one of air, nitrogen, and argon gas. In this exemplary embodiment, the light exiting from the first polarizing plate 2210 is refracted by exiting from an upper surface of the polarizing plate 2210 into the opening 2350, and then refracted by entering the lower surface of the second polarizing plate 2220 from the opening 2350. Thus, optical characteristics, e.g., luminance uniformity and viewing angle, may improve. Prism pattern (not shown), convex and concave pattern (not shown), light diffusion pattern (not shown), etc. may be formed on an upper surface of the first polarizing plate 2210 and on a lower surface of the second polarizing plate 2220. In another exemplary embodiment, a portion of the upper surface of the first polarizing plate 2210 and a portion of the lower surface of the second polarizing plate 2220 may be contacted closely by the opening 2350 of the light blocking pattern 2300. A space between the first polarizing plate 2210 and the second polarizing plate 2220 may be omitted by the opening 2350 of the light blocking pattern 2300, e.g., the light blocking pattern 2300 may be in directed contact with each of the first and second polarizing plates 22210 and 2220.

The hard coating layer 2400 is disposed on an upper surface of the second polarizing plate 2220. In this exemplary embodiment, the hard coating layer 2400 is in direct contact with the upper surface of the second polarizing plate 2220. The hard coating layer 2400 improves a surface hardness of the optical sheet assembly 2000 to protect the optical sheet assembly from an external shock, a scratch, etc.

According to this exemplary embodiment, the light blocking pattern 2300 is disposed between the first polarizing plate 2210 and the second polarizing plate 2220 to have a flat surface of the optical sheet assembly. The space between the first polarizing plate 2210 and the second polarizing plate 2220 is formed by the opening 2350 to improve optical characteristics.

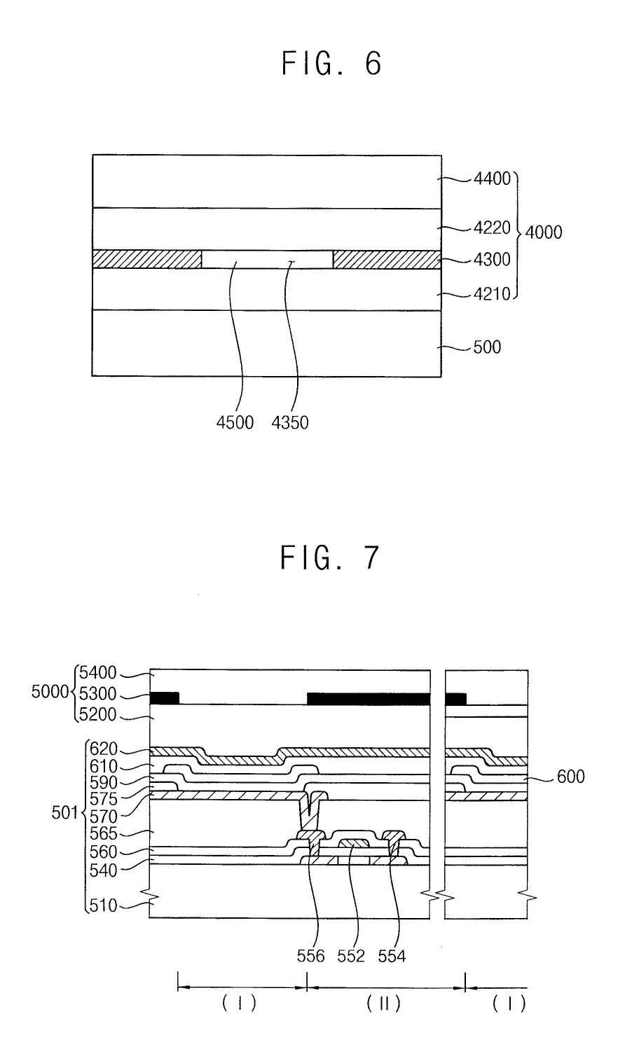

FIG. 5 is a cross-sectional view illustrating the display device in accordance with another example embodiment. In this exemplary embodiment, parts except the light blocking pattern 2300, the polarizing plate 2200, and an overcoating layer 3500 are substantially the same as the exemplary embodiment described with reference to FIGS. 1 to 3. Thus detailed descriptions thereof will be omitted.

Referring the FIG. 5, an optical sheet assembly 300 includes a polarizing plate 3200, a light blocking pattern 3300, an overcoating layer 3500, and a hard coating layer 3400. The polarizing plate 3200, the light blocking pattern 3300, the overcoating layer 3500, and the hard coating layer 3400 are integrally formed within the optical sheet assembly 3000. The optical sheet assembly 3000 is disposed on the display panel 500. In this exemplary embodiment, the optical sheet assembly integrally attached to the display panel 500 to form the display device.

The polarizing plate 3200 polarized a light exiting from the display panel 500. The polarizing plate 3200 is disposed on the display panel 500 to contact to the display panel 500. In this exemplary embodiment, an entire surface of the polarizing panel 3200 is combined with an entire surface of the display panel 500.

The light blocking pattern 3300 blocks the portion of the light having passed through the polarizing plate 1200 to improve a contrast ratio of an image. The light blocking pattern 3300 may be formed by printing, a photo process, a photo resist process, etc

The overcoating layer 3500 is disposed on the polarizing plate 3200 to cover the light blocking pattern 3300. For example, the overcoating layer 3500 seals the light blocking pattern 3300 and exposes an opening 3350 of the light blocking pattern 3300. The overcoating layer 3500 includes organic polymer materials, e.g., photo resist, epoxy, acryl, etc. In this exemplary embodiment, the overcoating layer 3500 coats a photo resist layer on the polarizing plate 3200, on which the light blocking pattern 3300 is formed. And then, the overcoating layer 3500 is formed by an exposure process and a development process. In another exemplary embodiment, the overcoating layer 3500 may include inorganic materials.

The hard coating layer 3400 is disposed on the polarizing plate 3200, on which the light blocking pattern 3300 and the overcoating layer 3200 are formed. In this exemplary embodiment, the hard coating layer 3400 is directly contacted to an upper surface of the polarizing plate 3200 being exposed by an upper surface of the overcoating layer and the opening 3350.

According to this exemplary embodiment, the overcoating layer 3500 is interposed between the light blocking pattern 3300 and the hard coating layer 3400 to prevent a chemical reaction between ink in the light blocking pattern 3300 and the hard coating layer 3400.

FIG. 6 is a cross-sectional view illustrating the display device in accordance with another example embodiment. In this exemplary embodiment, remaining parts except a light blocking pattern 4300, a first polarizing plate 4210, a second polarizing plate 4220, and an overcoating layer 4500 are substantially the same as the exemplary embodiment described with reference to FIGS. 1 to 3. Thus, detailed descriptions thereof will be omitted.

Referring to FIG. 6, an optical assembly 4000 includes the first polarizing plate 4210, the light blocking pattern 4300, the overcoating layer 4500, the second polarizing plate 4220, and the hard coating layer 4400. The first polarizing plate 4210, the light blocking pattern 4300, the overcoating layer 4500, the second polarizing plate 4220, and the hard coating layer 4400 are integrally formed with the optical sheet assembly 4000. The optical sheet assembly 4000 is disposed on the display panel 500. In this exemplary embodiment, the optical sheet assembly 4000 is integrally attached to the display panel 500 to form the display device.

The first polarizing plate 4210 polarizes a light exiting from the display panel 500. The first polarizing plate 4210 is disposed on the display panel 500 to contact the upper surface of the display panel 500. In this exemplary embodiment, an entire surface of the first polarizing plate 4210 is combined with an entire surface of the display panel 500.

The light blocking pattern 4300 blocks the portion of the light having passed through the polarizing plate 4210 to improve a contrast ratio of an image. The light blocking pattern 4300 may be formed by printing, a photo process, a photo resist process, etc. The light blocking pattern includes the opening 4350, which passes light therethrough.

An overcoating layer 4500 is disposed on the light blocking pattern 4210 to cover a side surface of the light blocking pattern 4300 and to fill the opening 4350. In this exemplary embodiment, the overcoating layer 4500 includes transparent polymer materials such as photo resist, epoxy, acryl, etc. In another exemplary embodiment, the overcoating layer 4500 is only disposed in the opening 4350. The overcoating layer 4500 includes photo resist and the overcoating layer is formed by a photo process. In another exemplary embodiment, overcoating layer 4500 is disposed not only in the 4500 but on an upper surface of the light blocking pattern 4300 and may seal the light blocking pattern 4300. The overcoating layer 4500 is formed by coating a photo resist and an extra process may be omitted.

The second polarizing plate 4220 polarizes the first polarized light having passed through the opening 4350 of the light blocking pattern 4300. In this exemplary embodiment, the degree polarized by the first polarization and the second polarization is the same as the degree polarized by the polarizing plate 1200 illustrated in FIGS. 1 to 3.

The second polarizing plate 4220 is disposed on the light blocking pattern 4300 and the overcoating layer 4500. In this exemplary embodiment, light exiting from the first polarizing plate 4210 toward the overcoating layer 4500 disposed in the opening 4350 is firstly reflected at the boundary surface between the first polarizing plate 4210 and the overcoating layer 4500. And, the light exiting from the first polarizing plate 4210 by the overcoating layer disposed in the opening 4350 is secondly reflected at the boundary surface between the second polarizing plate 4220 and the overcoating layer 4500.

Thus, optical characteristics such as luminance uniformity and viewing angle may improve. Prism pattern, convex and concave pattern, light diffusion pattern, etc may be formed on a surface of the first polarizing plate and the lower surface of the second polarizing plate. In another exemplary embodiment, bubbles, diffusion bids, etc. may be disposed in the overcoating layer 4500.

The hard coating layer 4400 is disposed on the second polarizing plate 4220. In this exemplary embodiment, the hard coating layer 4400 directly contacts the upper surface of the second polarizing plate 4220. The hard coating layer 4400 improves a surface hardness of the optical sheet assembly 4000 to protect the optical sheet assembly 4000 from an external shock or a scratch.

According to this exemplary embodiment, the light blocking pattern 4300 is disposed between the first polarizing plate 4210 and the second polarizing plate 4220 to have flat surface of an optical sheet assembly. The overcoating layer 4500 is formed between the first polarizing plate 4210 and the second polarizing plate 4220 to improve optical characteristics. Also, ink in the light blocking patter 4300 is prevented from diffusing into the opening 4350.

FIG. 7 is a cross-sectional view illustrating the display device in accordance with another example embodiment. In this exemplary embodiment, remaining parts except a second substrate 660 of FIG. 3 and the polarizing plate 5200 are the same as the exemplary embodiment described with reference to FIGS. 1 to 3. Thus, detailed descriptions thereof will be omitted. Referring to FIG. 7, the display device includes a display panel 501 and an optical sheet assembly 5000.

The optical sheet assembly 5000 includes a polarizing plate 5200, a light blocking pattern 5300, and a hard coating layer 5400. The polarizing plate 5200, the light blocking pattern 5300, and the hard coating layer 5400 are integrally formed with the optical sheet assembly 5000. The optical sheet assembly 5000 is disposed on the display panel 501. In this exemplary embodiment, the optical sheet assembly 1000 is integrally formed with the display panel 501.

The polarizing plate 5200 polarizes light exiting from the display panel 501 to display an image on the display device. For example, the polarizing plate 5200 includes an anisotropic mineral substrate such as triacetate cellulose (TAC) film, polycarbonate (PC) film, polyvinyl acetate (PVA) film, grid polarizing plate, calcite, etc. The polarizing plate 5200 is disposed on display panel 501 to make contact with the upper surface of the display panel 501. In this exemplary embodiment, an entire surface of the polarizing plate 5200 is integrally combined with the entire upper surface of the display panel 501 to form the display device.

The polarizing plate 5200 polarizes light exiting from the display panel 501 to display an image on the display device. For example, the polarizing plate 5200 includes triacetate cellulose (TAC) film, polycarbonate (PC) film, polyvinyl acetate (PVA) film, grid polarizing plate, an anisotropic mineral substrate such as calcite, etc. The polarizing plate 5200 is disposed on display panel 501 to make contact with an upper surface of the display panel 501. An entire surface of the polarizing plate 5200 is combined with an entire upper surface of the display panel. In this exemplary embodiment, a lower surface of the polarizing plate 5200 is contacted with a second electrode 620 of the display panel 501. The display panel 501 may include the pixel area I and the peripheral area II surrounding the pixel area I.

The display panel 501 has a stacked structure of the first substrate 510, the gate insulator film 540, the first insulator layer 560, the second layer 565, the first electrode 570, the pixel defining layer 575, the hole transfer layer 590, the organic light emitting layer 600, the electron transfer layer 610, and the second electrode. A switching device disposed on the first substrate 510 includes a thin film transistor including the gate electrode 552, the source electrode 554, the drain electrode 556, the semiconductor layer 530, etc.

In a process of manufacturing a display device, the display panel 501 is formed, and then the display device is formed by stacking the polarizing plate 5200, the light blocking pattern 5300, and the hard coating layer 5400 sequentially on the second electrode 620 of the display panel 501. In another exemplary embodiment, the display panel 501 and the optical sheet assembly 5200 may be separately formed, and then be combined.

In this exemplary embodiment, the second substrate 660 of FIG. 3 is omitted. The polarizing plate 5200 performs a function of the second substrate to make the thickness of the display device reduced and make manufacturing process simple.

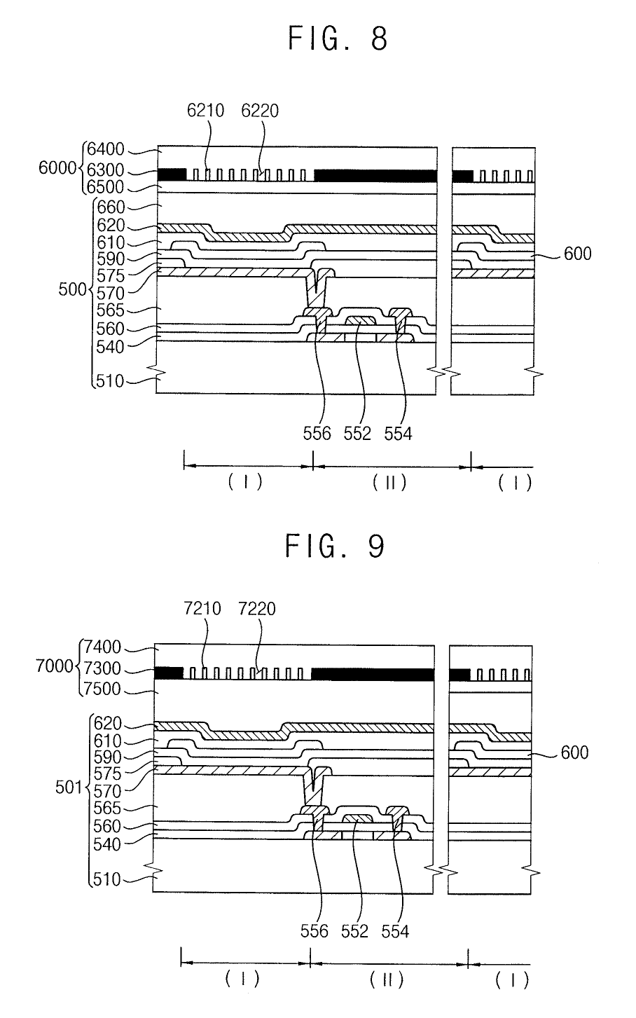

FIG. 8 is a cross-sectional view illustrating the display device in accordance with another example embodiment. In this exemplary embodiment, remaining parts except a base substrate 6500 and a polarizing pattern 6320 are substantially the same as the exemplary embodiment described with reference to FIGS. 1 to 3. Thus, detailed descriptions thereof will be omitted.

Referring to FIG. 8, the display device includes the display panel 500 and the optical sheet assembly 6000. The optical sheet assembly 6000 includes a base substrate 6500, a light blocking pattern 6300, a polarizing pattern 6210, and a hard coating layer.

The base substrate 6500 may include a transparent insulator substrate. In this exemplary embodiment, the base substrate 6500 may include glass substrate, quartz substrate, a transparent plastic substrate, etc. For example, the base substrate 6500 may include such as polyethylene terephthalate resin, polyester resin, a polyacryl resin, polyepoxy resin, polyethylene resin, a polystyrene resin, polyethylene naphthalate resin, poly carbonate resin, poly vinyl chloride resin, polypropylene resin, cyclo olefin copolymer, triacetyl cellulose, a mixture thereof, etc. In other exemplary embodiments, the base substrate 6500 may include a flexible substrate.

The light blocking pattern 6300 blocks the portion of the light having passed through the base substrate 6500 to improve a contrast ratio of an image. The light blocking pattern 6300 is formed in the peripheral area II, and opens the pixel area I. The light blocking pattern 6300 blocks the peripheral area II. In this exemplary embodiment, the polarizing pattern 6210 is directly formed on the base substrate 6500.

In this exemplary embodiment, the polarizing pattern 6210 includes a grid polarizing pattern including the multiple wire grid patterns. Each grid pattern has dozens to hundreds of pitch, width, and height. For example, each grid pattern may have 80 nm˜120 nm of pitch, 50 nm˜100 nm of width, and 100 nm˜200 nm of height. For example, the polarizing pattern 6210 includes an opaque material such as ink, dye, ink, metal, etc. When the polarizing pattern 6210 includes a metal, aluminum (Al), titanium (Ti), chrome (Cr), silver (Ag), nickel-chrome alloy, gold (Au), etc. A groove may be formed on the base substrate, and the polarizing pattern 6210 may be formed in the groove. Light passing through spaces 6220 between adjacent grid patterns is polarized by diffraction, reflection, deflection, etc.

In this exemplary embodiment, the light blocking pattern 6300 and the polarizing pattern 6210 include the same material and both are formed in the same layer. The light blocking pattern 6300 and the polarizing pattern 6210 may be formed by printing, a photo process, a photo resist process, etc. For example, the light pattern 6300 and the polarizing pattern 6210 may be formed by depositing a metal film on the polarizing plate and partially etching the deposited metal film. The light blocking pattern 6300 and the polarizing pattern 6210 are formed in the same layer and the light blocking pattern 6300 and the polarizing pattern 6210 may further form an information pattern displaying a company logo, a proprietary name, an identification number, etc.

The hard coating layer 6400 disposed on the base substrate 6210, on which the light blocking pattern 6300 and the polarizing pattern 6210 are formed, covers the light blocking pattern 6300 and the polarizing pattern 6210. In this exemplary embodiment, the hard coating layer 6400 is directly contacted with an upper surface of the light blocking pattern, an upper surface and a side of the polarizing pattern 6210, and an upper surface of the base substrate 6500.

In the example embodiment, the optical sheet assembly 6000 includes the polarizing pattern 6210 having a grid pattern instead of a polarizing plate to enhance the luminance. The light blocking pattern 6300 and the polarizing pattern 6210 are formed at the same time to make the manufacturing process simple.

FIG. 9 is a cross-sectional view illustrating the display device in accordance with another example embodiment. In this exemplary embodiment, remaining parts except a base substrate 7500 and a polarizing pattern 7210 plate are the same as the exemplary embodiment described with reference to FIG. 7. Thus, detailed descriptions thereof will be omitted.

Referring to FIG. 9, a display device includes an optical assembly 7000. The optical sheet assembly 7000 includes the base substrate 7500, a light blocking pattern 7300, the polarizing pattern 7210, and a hard coating layer 7400.

The light blocking pattern 7300 and the polarizing pattern 7210 are directly formed on the base substrate 7500. The polarizing pattern 7210 includes a grid pattern having the multiple wire grid patterns. In this exemplary embodiment, the light blocking pattern 7300 and the polarizing pattern 7210 include the same material. The light blocking pattern 7300 and the polarizing pattern 7210 are formed in the same layer.

The hard coating layer 7400 is disposed on the base substrate 7500, on which the light blocking pattern 7300 and the polarizing pattern 7210 are formed, to cover the light blocking pattern 7300 and the polarizing pattern 7210. In the exemplary embodiment, luminance of a display device may improve. Also, manufacturing process may be simple and thickness may be thin.

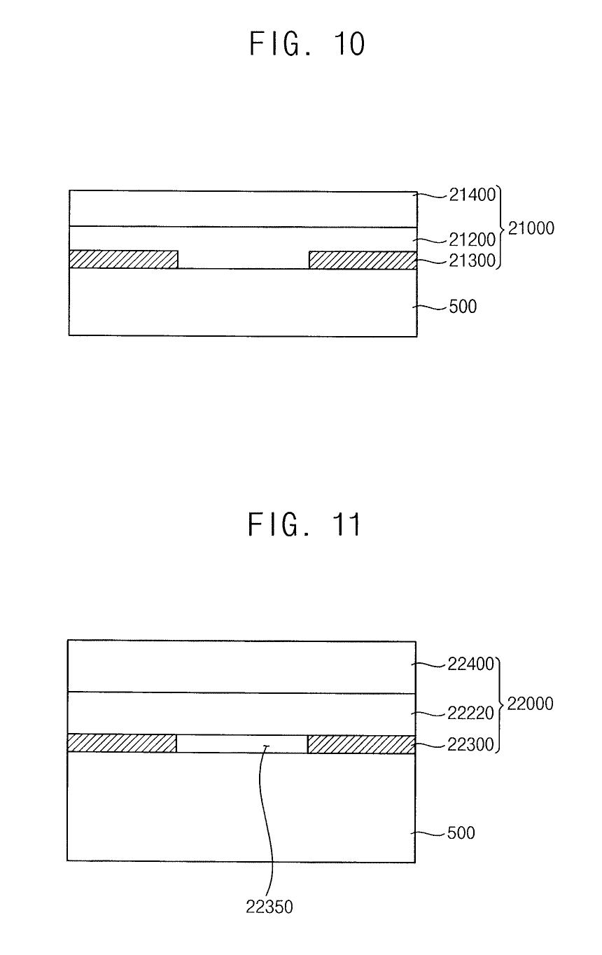

FIG. 10 is a cross-sectional view illustrating the display device in accordance with another example embodiment. In this exemplary embodiment, remaining parts except the light blocking pattern 21300 are the same as the exemplary embodiment described with reference to FIGS. 1 to 3. Thus, detailed descriptions thereof will be omitted.

Referring to FIG. 10, a display device includes an optical assembly 21000 and the display panel 500.

The optical sheet assembly 21000 includes a polarizing plate 21200, a light blocking pattern 21300, and a hard coating layer 21400. The polarizing plate 21200, the light blocking pattern 21300, and the hard coating layer 21400 are integrally combined to form the optical sheet assembly 1000. The optical sheet assembly 21000 is disposed on the display panel 500.

The polarizing plate 21200 polarizes light exiting from the display panel 500 to display an image on the display device. The polarizing plate 21200 is disposed on the display panel 500 to contact with the upper surface of the display panel 500.

The light blocking pattern 21300 is disposed between the display panel 500 and the polarizing plate 21200. The light blocking pattern 21300 blocks the portion of the light having passed through the display panel 500 to improve a contrast ratio of an image. An information pattern 1390 of FIG. 1 displaying a company logo, a proprietary name, an identification number, etc. may be formed in the same layer with the light blocking pattern 21300.

The hard coating layer is disposed on the polarizing plate 21200 to cover the polarizing plate 21200. In this exemplary embodiment, the hard coating layer 21400 is directly contacted with an entire surface of the polarizing plate 21200. The hard coating layer 21400 may include a low-reflection coating. Transparent film such as a retardation film, a TAC film, a PC film, a PVA film, etc. may be interposed between the polarizing plate 1200 and the display panel 500. In this exemplary embodiment, the hard coating layer 1400 is directly formed on the polarizing plate to omit extra glass substrate and synthetic resin substrate.

FIG. 11 is a cross-sectional view illustrating the display device in accordance with another example embodiment. In this exemplary embodiment, remaining parts except a light blocking pattern 22300 and a polarizing pattern 22220 are the same as the exemplary embodiment described with reference to FIG. 4. Thus, detailed descriptions thereof will be omitted.

Referring to FIG. 11, the optical assembly 22000 includes the light blocking pattern 22300, the first polarizing plate 22200, and a hard coating layer 22400. The light blocking pattern, the polarizing plate 22220 and the hard coating layer 22220 are integrally formed with the optical sheet assembly 4000. The optical sheet assembly 22000 is disposed on the display panel 500. In this exemplary embodiment, the optical sheet assembly 22000 is integrally attached to the display panel 500 to form the display device.

The light blocking pattern 22300 is disposed between the polarizing plate 22220 and the display panel 500. For example, the light blocking pattern 22300 may be formed by printing, a photo process, a photo resist process, etc. The light blocking pattern 22300 blocks the portion of the light from the display panel 500 to improve a contrast ratio of an image

The polarizing plate 22220 is disposed on the display panel 500. The polarizing plate 22220 polarizes the light passed through an opening 22350 of the light blocking pattern 22300. The polarizing plate 22220 is disposed on the light blocking pattern 22300 to form the space where the opening 22350 is disposed.

For example, the space in the opening 22350 is vacuum or is filled with air, nitrogen, and/or argon gas, etc. In this exemplary embodiment, the light exiting from the display panel 500 toward the space in the opening 22350 is firstly refracted by exiting from an upper surface of the display panel and secondly reflected by entering the lower surface of the second polarizing plate 22220. Thus, optical characteristics such as luminance uniformity, viewing angle improve. Prism pattern, convex and concave pattern, light diffusion pattern, etc. may be formed on the upper surface of the display panel 500 and a lower surface of the polarizing plate 22220. In another exemplary embodiment, a portion of the upper surface of the display panel 500 and the portion of the lower surface of the polarizing plate 22220 may be contacted closely by the opening 22350 of the light blocking pattern 22300. Also, the space between the display panel 500 and the polarizing plate 22220 may be omitted by the opening 22350 of the light blocking pattern 2300.

The hard coating layer 22400 is disposed on the polarizing plate 22220. In this exemplary embodiment, the hard coating layer 22400 is directly contacted with an upper surface of the polarizing plate 22220. In the exemplary embodiment, the space between the display panel 500 and the polarizing plate 22220 is formed by the opening 22350 to improve optical characteristics.

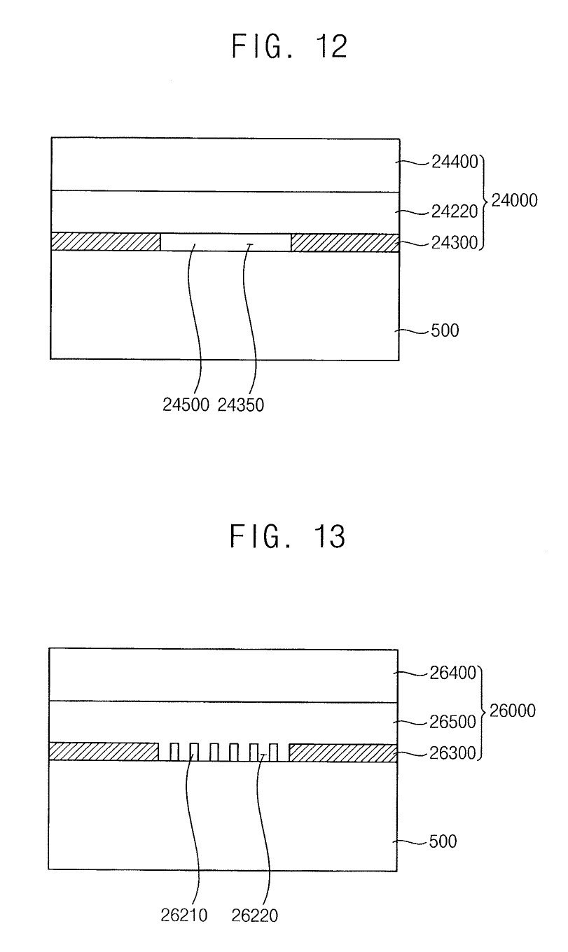

FIG. 12 is a cross-sectional view illustrating the display device in accordance with another example embodiment. In this exemplary embodiment, the overcoating layer 24500 is the same as the exemplary embodiment described with reference to FIG. 11. Thus, detailed descriptions thereof will be omitted.

Referring to FIG. 12, an optical assembly 24000 includes the light blocking pattern 24300, the overcoating layer 24500, the polarizing plate 24300, and a hard coating layer 24220. The light blocking pattern 24300, the overcoating layer 24500, the polarizing plate 24220 and the hard coating layer 24400 are integrally formed with the optical sheet assembly 24000. The optical sheet assembly 24000 is disposed on the display panel 500. In this exemplary embodiment, the optical sheet assembly 24000 is integrally attached to the display panel 500 to form the display device

The polarizing plate 24220 is disposed on the display panel 500. A light blocking pattern 24300 is disposed between the display panel 500 and the polarizing plate 24220. For example, the light blocking pattern 24300 may be formed by printing, a photo process, a photo resist process, etc. on an upper surface of the display panel 500. The light blocking pattern 24300 may also be formed by printing, a photo process, a photo resist process, etc. on a lower surface of the polarizing plate 24220. The light blocking pattern 24300 blocks the portion of the light having passed through the display panel 500 to improve a contrast ratio of an image. The light blocking pattern includes an opening 24350, which makes light pass through.

The overcoating layer 24500 fills the opening 24350 of the light blocking pattern 24300. In this exemplary embodiment, the overcoating layer 24500 includes transparent polymer materials such as photo resist, epoxy, acryl, etc. For example, the overcoating layer 24500 is disposed only in the opening 24350. In another embodiment, the overcoating layer 24500 is disposed not only in the opening 24350 but an upper side of the light blocking pattern 24300 to seal the light blocking pattern 24300 and cover an entire surface of the display panel 500.

The polarizing plate 24220 polarizes the light having passed through an opening 44350 of a light blocking pattern 444300. The polarizing plate 24220 is disposed on the light blocking pattern 24300 and the overcoating layer 24500. In this exemplary embodiment, the light exiting from the display panel 500 by the overcoating layer 24500 disposed in the opening 24350 is firstly reflected at the boundary surface between the polarizing plate 24220 and the overcoating layer 24500. And, the light exiting from the first polarizing plate 24220 by the overcoating layer disposed in the opening 24350 is secondly reflected at the boundary surface between the second polarizing plate and the overcoating layer 24500.

Thus, optical characteristics such as luminance uniformity, viewing angle improve. Prism pattern, convex and concave pattern, light diffusion pattern, etc may be formed on an upper surface of the display panel 500 and the lower surface of the polarizing plate 24220. In another exemplary embodiment, bubbles, diffusion bids, etc. may be disposed in the overcoating layer 4500.

The hard coating layer 24400 is disposed on the polarizing plate 24220. In this exemplary embodiment, the hard coating layer 24400 is directly contacted with an upper surface of the polarizing plate 24220.

According to this exemplary embodiment, the overcoating layer is formed between the display panel 500 and the polarizing plate to improve the optical characteristics and prevent ink from diffusing into the opening 24350.

FIG. 13 is a cross-sectional view illustrating the display device in accordance with another example embodiment of the present invention. In this exemplary embodiment, remaining parts except a polarizing pattern 26210 and a transparent film 26500 are the same as the exemplary embodiment described with reference to FIG. 10. Thus, detailed descriptions thereof will be omitted.

Referring to FIG. 13, a display device includes an optical sheet assembly 26000 and the display panel 500. The optical sheet assembly 26000 includes the transparent film 26500, a light blocking pattern 26300, a polarizing pattern 26210 and a hard coating layer 26400. The transparent film 26500, the light blocking pattern 26300, the polarizing pattern 26210 and the hard coating layer 26400 are integrally formed with the optical sheet assembly 26000.

The transparent film 26500 is disposed on the display panel 500. The light blocking pattern 26300 and the polarizing pattern 26210 is disposed between the display panel 500 and the transparent film 26500.

The light blocking pattern 26300 blocks the portion of the light having passed through the display panel 500 to improve a contrast ratio of an image. The polarizing pattern 26210 includes a grid pattern having the multiple wire grid patterns. In this exemplary embodiment, the light blocking pattern 26300 and the polarizing pattern 26210 include the same material. The light blocking pattern 26300 and the polarizing pattern 26210 are formed from the same layer.

An information pattern 1390 of FIG. 1 displaying a company logo, a proprietary name, an identification number, etc. may be formed from the same layer with the light blocking pattern 26300 and the polarizing pattern 26210.

The hard coating layer is disposed on the polarizing plate 26500 to cover the transparent film 26500. In this exemplary embodiment, the hard coating layer 26400 is directly contacted with an entire surface of the transparent film 26500. The hard coating layer 26400 may include a low-reflection coating.

A transparent film such as a retardation film, a TAC film, a PC film, a PVA film, etc. may be interposed between the polarizing plate 26300 and the display panel 500.

In another exemplary embodiment, the transparent film 26500 may be omitted and the hard coating layer 26400 may be directly formed on the light blocking pattern 26300 and the polarizing pattern 26210.

In this exemplary embodiment, the hard coating layer 26400 is directly formed on the transparent film 26500 to omit extra glass substrate and synthetic resin substrate. Also, the luminance of a display device improves.

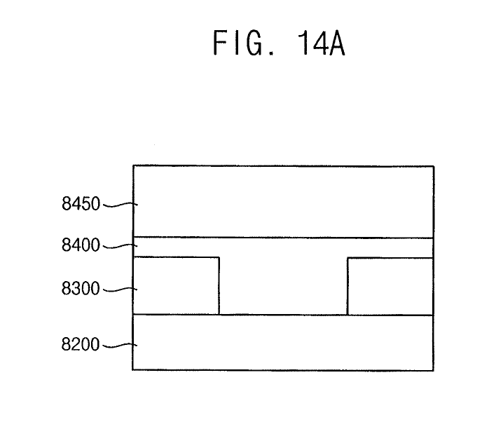

FIG. 14A is a cross-sectional view illustrating the display device in accordance with another example embodiment. FIG. 14B is the image illustrating the surface of an optical sheet in FIG. 14A.

Referring FIG. 14A and FIG. 14B, an optical sheet assembly includes a polarizing plate 8200, a light blocking pattern 8300, a hard coating layer 8400, and a low reflection layer 8450. In this exemplary embodiment, the polarizing plate 8200 includes TAC film.

The light blocking pattern 8300 blocks the portion of the light having passed through the polarizing plate 8200 to improve a contrast ratio of an image. The hard coating layer 8400 is disposed on the polarizing plate 8200, which the light blocking pattern 8300 is formed with, to cover the light blocking pattern 8300 and the polarizing plate 8200. The low-reflection coating layer 8450 is disposed on the hard coating layer 8400 to degrade the flexibility of the surface. Thus, the reflectivity of the light entering from the exterior decreases to improve contrast ratio of an image.

The low-reflecting coating 8450 may include, e.g., chrome, silica particles, etc. For example, chrome may be disposed on the hard coating layer 8400 to form the low-reflection coating layer 8450.

Referring FIG. 14B, the uniformity of the surface may be degraded by a chemical reaction of ink between the hard coating layer 8400 and the light blocking pattern 8300. In this exemplary embodiment, the reflectivity of external light is decreased by the low-reflection coating layer 8450 to improve the contrast ratio.

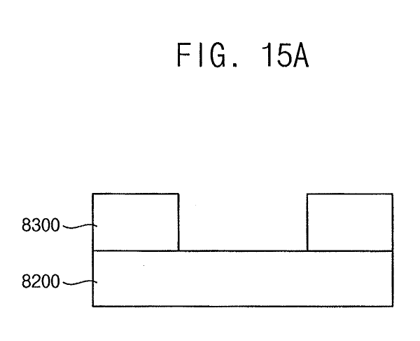

FIG. 15A is a cross-sectional view illustrating the display device in accordance with another example embodiment. FIG. 15B is the image illustrating the surface of an optical sheet in FIG. 15A.

Referring FIG. 15A and FIG. 15B, an optical sheet assembly includes a polarizing plate 8200 and a light blocking pattern 8300. In this exemplary embodiment, the polarizing plate 8200 includes TAC film. The light blocking pattern 8300 blocks the portion of the light having passed through the display panel 8200 to improve a contrast ratio of an image. Referring FIG. 15B, an optical sheet assembly only formed by the polarizing plate 8200 and the light blocking pattern 8300 has a flat surface.

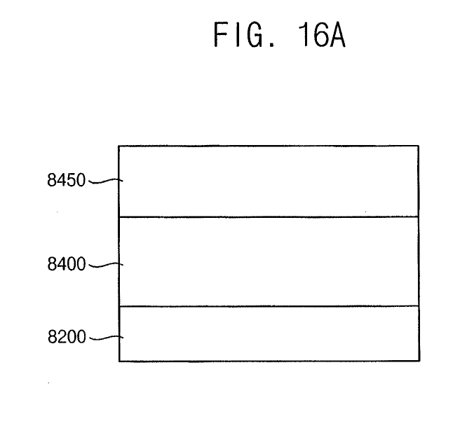

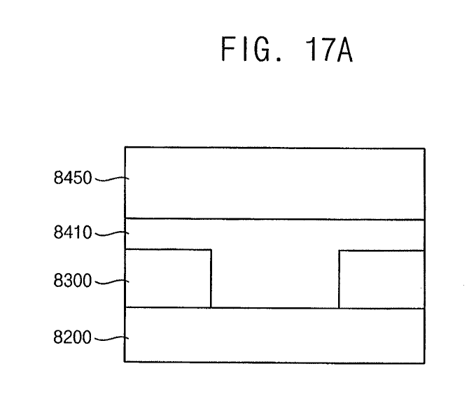

FIG. 16A is a cross-sectional view illustrating the display device in accordance with another example embodiment. FIG. 16B is the image illustrating the surface of an optical sheet in FIG. 16A.

Referring FIG. 16a and FIG. 16B, an optical sheet assembly includes the polarizing plate 8200, the hard coating layer 8300, and the low-reflection coating layer 8450. In this exemplary embodiment, the polarizing plate 8200 includes TAC film.

The hard coating layer 8400 is disposed on the polarizing plate 8200. The low-reflection coating layer 8450 is disposed on the hard coating layer to degrade the reflectivity of the surface. Referring FIG. 16B, an optical sheet assembly composed of the polarizing plate 8200, the hard coating layer 8300, and the low-reflection coating layer 8450 has flat surface.

FIG. 17A is a cross-sectional view illustrating the display device in accordance with another example embodiment. FIG. 17B is the image illustrating the surface of an optical sheet in FIG. 17A. In this exemplary embodiment, remaining parts except the hard coating layer 8410 is the same as the exemplary embodiment described with reference to FIG. 10A. Thus, detailed descriptions thereof will be omitted

Referring FIG. 17A and FIG. 17B, an optical sheet assembly includes the polarizing plate 8200, the light blocking pattern 8300, and the low-reflection layer 8450. The light blocking pattern 8300 blocks the portion of the light having passed through the polarizing plate 8200 to improve a contrast ratio of an image. The hard coating layer 8410 is disposed on the polarizing plate 8200 to cover the light blocking pattern 8300 and the polarizing plate 8200. The hard coating layer 8410 of this exemplary embodiment irradiates more UV rays than the hard coating layer 8400 of FIG. 10A. When more UV rays are irradiated during formation of the hard coating layer 8410, the drying amount may be increased to eliminate solvent in the hard coating layer 8410. The low-reflection coating layer 8450 is disposed on the hard coating layer 8400 to degrade the reflectivity of the surface. Thus, the reflectivity of the light entering from the exterior is degraded to improve the contrast of an image. The low-reflection coating layer 8450 may include, e.g., chrome, a particle of silica, etc. For example, chrome may be disposed on the hard coating layer 8400 to form the low-reflection coating layer 8450. Referring FIG. 17A, although the irradiation mount of the hard coating layer 8410 increases to eliminate the solvent in the hard coating layer 8410, an optical sheet assembly has uneven surface.

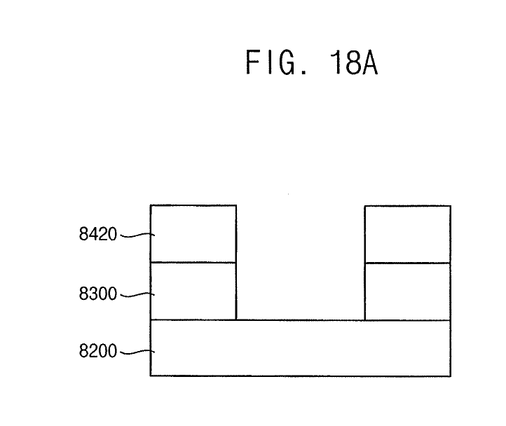

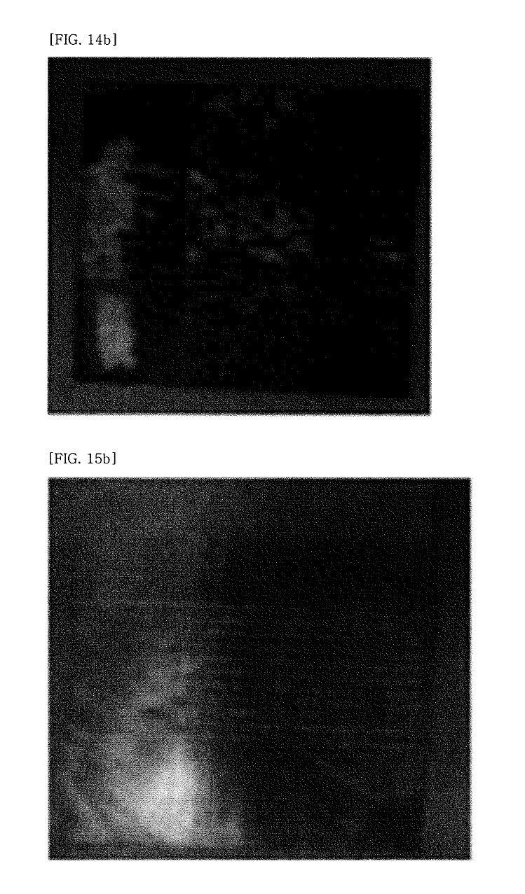

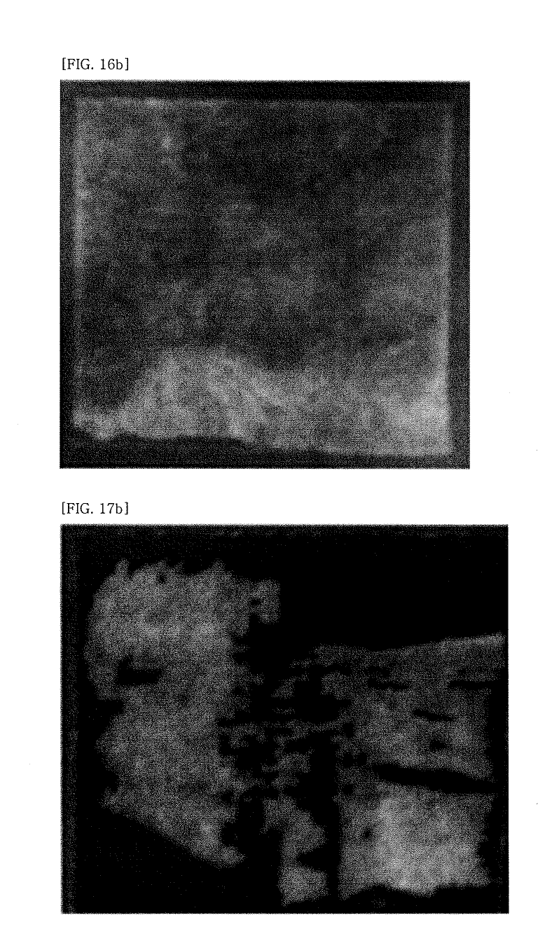

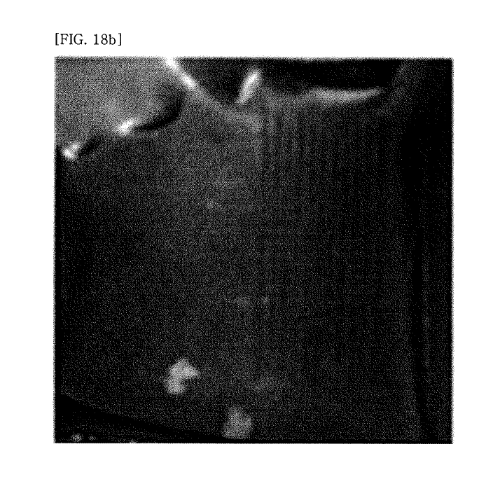

FIG. 18A is a cross-sectional view illustrating the display device in accordance with another example embodiment. FIG. 18B is the image illustrating the surface of an optical sheet in FIG. 18A.

Referring FIG. 18a and FIG. 18B, an optical sheet assembly includes the polarizing plate 8200, the light blocking pattern 8300, and a solvent layer 8420.

The light blocking pattern 8300 blocks the portion of the light having passed through the polarizing plate 8200 to improve a contrast ratio of an image. The solvent layer 8420 is disposed on the light blocking pattern 8300 to cover the light blocking pattern 8300. Referring FIG. 18B a chemical reaction between solvent in the solvent layer 8420 and ink in the light blocking pattern 8300 occurs to have optical sheet assembly the uneven surface.

According to an optical sheet assembly and a display apparatus having the optical sheet assembly of the example embodiments, an optical sheet assembly may be formed omitting an extra cover glass. In other words, the number of glass substrate or the number of plastic substrate is decreased to form the integrated optical sheet assembly. Thus, when the optical sheet assembly is applied to a display device, the thickness of a display device may be reduced and luminance of display device may improve. Further, assembly efficiency may be improved, i.e., assembly progress may be simple and malfunction may be reduced.

In contrast, in a conventional display device, various optical sheets are needed to upgrade quality of images. When the number of optical sheet in one display device increases, a thickness of the display device increases. Also, assemblage efficiency may decrease and manufacturing costs may increase.

Example embodiments provide methods an organic light emitting display devices, however, a display device including various display panels such as a liquid crystal display panel and an electrophoresis display panel, etc. may be included.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. An optical sheet assembly disposed on a display panel including a pixel area displaying an image and a peripheral area surrounding the pixel area, the optical sheet assembly, comprising:
a polarizing plate on the display panel;
a light blocking pattern on the polarizing plate, a portion of the polarizing plate in the pixel area being exposed through openings in the light blocking pattern; and
a hard coating layer on the polarizing plate, the hard coating layer covering an upper surface of the light blocking pattern and the exposed portion of the polarizing plate in the pixel area.

2. The optical sheet assembly of claim 1, further comprising an information pattern directly on the polarizing plate, the information pattern displaying at least one of a company logo, a proprietary name, and an identification number.

3. The optical sheet assembly of claim 1, wherein the polarizing plate includes a first polarizing plate and a second polarizing plate, the light blocking pattern being between the first and the second polarizing plates.

4. The optical sheet assembly of claim 3, wherein a space is defined by the openings of the light blocking pattern, the space being between an upper surface of the first polarizing plate and a lower surface of the second polarizing plate.

5. The optical sheet assembly of claim 4, wherein the space includes vacuum or at least one of air, nitrogen, and argon gas.

6. The optical sheet assembly of claim 4, further comprising an overcoating layer in the space, the overcoating layer covering a side surface of the light blocking pattern.

7. The optical sheet assembly of claim 1, further comprising an overcoating layer between the hard coating layer and the light blocking pattern to cover the light blocking pattern.

8. The optical sheet assembly of claim 1, wherein the light blocking pattern is directly on the polarizing plate.

9. The optical sheet assembly of claim 8, wherein the hard coating layer directly contacts the light blocking pattern and fills the openings in the light blocking pattern to directly contact the polarizing plate.

10. An optical sheet assembly disposed on a display panel including a pixel area displaying an image and a peripheral area surrounding the pixel area, the optical sheet assembly, comprising:
a polarizing plate on the display panel;
a light blocking pattern on the polarizing plate, the light blocking pattern being between the display panel and the polarizing plate, and a portion of the light blocking pattern corresponding to the pixel area including openings therethrough; and
a hard coating layer on the polarizing plate.

11. An optical sheet assembly disposed on a display panel including a pixel area displaying an image and a peripheral area surrounding the pixel area, the optical sheet assembly, comprising:
a base substrate on the display panel;
a blocking light pattern on the base substrate;
a polarizing pattern on the base substrate in the pixel area; and
a hard coating layer on the base substrate.

12. The optical sheet assembly of claim 11, wherein the light blocking pattern and the polarizing pattern are in a same layer, the hard coating layer directly covering upper surfaces of the light blocking pattern and the polarizing pattern.

13. The optical sheet assembly of claim 11, wherein the polarizing pattern includes a grid pattern.

14. A display device, comprising:
a display panel including a pixel area displaying an image and a peripheral area surrounding the pixel area; and
an optical sheet assembly, the optical sheet assembly including:
a polarizing plate on the display panel,
a light blocking pattern on the polarizing plate, a portion of the polarizing plate in the pixel area being exposed through openings in the light blocking pattern, and
a hard coating layer on the polarizing plate, the hard coating layer covering an upper surface of the light blocking pattern and the exposed portion of the polarizing plate in the pixel area.

15. The display device of claim 14, further comprising an information pattern directly on the polarizing plate, the information pattern displaying at least one of a company logo, a proprietary name, and an identification number.

16. The display device of claim 14, further comprising an overcoating layer disposed between the hard coating layer and light block pattern to cover the light blocking pattern.

17. The display device of claim 14, wherein the display panel is an organic electro-luminescent display panel, a liquid crystal display panel, or an electrophoresis display panel.

18. The display device of claim 14, wherein the display panel includes a first substrate, a switching device disposed on the first substrate, and a display element electrically connected to the switching element.

19. The display device of claim 18, wherein an electrode of the display element is covered by the optical sheet assembly.

20. The display device of claim 18, wherein the display panel further comprises a second substrate covering the display element, the optical sheet assembly being disposed on the second substrate.
